(19) United States
(12) Patent Application Publication
(10) Pub. No.: US 2012/0041916 A1
(43) Pub. Date: Feb. 16, 2012

(54) METHOD AND DEVICE FOR SUPERVISING THE TREATMENT OF A CROP

(75) Inventor: Eric Jallas, Clapiers (FR)

(73) Assignee: ITK, Clapiers (FR)

(21) Appl. No.: 13/144,800

(22) PCT Filed: Jan. 15, 2010
(86) PCT No.: PCT/FR2010/050062

§ 371 Date: Oct. 11, 2011

(30) Foreign Application Priority Data
Jan. 15, 2009 (FR) 0900185
Jan. 15, 2009 (FR) 0900186

(51) Int. Cl. G06N 5/02; G06F 17/00

(52) U.S. Cl. 706/46

(57) ABSTRACT

A method for supervising the treatment of a crop combines a field record, models of plants, diseases or insects and active substances coupled together, and includes, at least once, the following steps:
a step in which the risk of contracting diseases to which the crop is exposed is determined, according to the results of a disease or insect model coupled with the plant model,
a step in which the level of protection of the crop is determined based on the last treatment applied, according to the results of a model of active substances coupled with the field record and the plant model,
a step in which the next recommended treatment is determined, according to the modeled change in the crop and the disease and/or insect since the last treatment carried out and
a step in which the next recommended treatment is displayed.

This invention relates to a method and device for monitoring the treatment of a crop. It applies, in particular, to the recommendation made to farmers for crop irrigation and/or treatment using, for example, fertilizers and/or plant protection products.

“Sustainable” agriculture is a farming approach in which the best possible compromise between agricultural productivity and environmental conservation is sought.

A major objective of sustainable agriculture is to adjust the amount of inputs (irrigation, fertilizers, and plant protection products) according to the actual needs of the crop. In this way it differs from intensive farming, where the use of these inputs is but slightly differentiated, at levels which are defined empirically and regionally as being sufficient (but often unnecessary) to achieve the maximum possible yield.

Within a single farm, and for a single crop, the actual needs may vary considerably from one plot to another and from one year to another. In theory, therefore, sustainable agriculture requires means to assess these needs plot by plot, and in real-time throughout the growing campaign.

In most cases, several treatments or applications of the same input must be made in the course of the campaign. Normally, therefore, sustainable farming is an iterative process where the applications previously carried out must be taken into account to determine whether to realize a new one, and if so at what date and with what quantity of input.

Agro-climatic models are, in theory, one of the main tools for implementing “sustainable” agriculture. These are algorithms based on ecophysiological knowledge of crops and their pests, which allow the following to be calculated, from a description of the crop, of the plot's soil and from climate variables:

the potential yield of the crop,

its water and nutrient element requirements (therefore making irrigation and fertilization sustainable) and

the risk of development of its major diseases and animal parasites (thus making plant protection treatments sustainable).

Currently, agro-climatic models are mainly used in two contexts:

use by agricultural consultants (private individuals, members of professional agricultural bodies, or public utilities). Since these consultants monitor a large number of farms, they cannot usually apply these standards to all the agricultural plots in the area where they work. So they just realize simulations on typical plots representing the main plot categories found in the region, and disseminate the results of these simulations to their members or clients. They must then identify for themselves the plot type closest to each of their plots, which is a source of error and of adverse approximations. Moreover, in this operating environment, it is impossible to take the inputs already applied by the farmer on the plot into account. This mode of operation makes it possible to determine (at the cost of hazardous approximations) on what date the first application of a class of input is to be carried out, but not to specify if further applications or treatments will be needed subsequently.

to integrate models (usually disease or pest models) in the software of weather stations sold to farmers. In this case, the model works well with weather data originating from the specific farm, but it works without taking plot factors into account, and therefore merely calculates an average weather-related risk for the farm.

Note that in both cases these operating modes strongly distort the purpose for which these models were designed: in effect, the scientists who originally created them validated them at plot scale. Thus, much of the accuracy of these models is lost, and so therefore is their potential efficacy in preserving the environment.

In parallel to these agro-climatic models, farmers use software or Web services that comprise a “field record” in which they record the main characteristics of their crops and their interventions on all these crops. These field records contain most of the information used by agro-climatic models, but this information is not used for lack of a coupling between these field records and the models.

Document WO 02/096189, which describes an automated crop monitoring system, is known. However, this system only provides autonomous recommendations for irrigation. In all other areas of treatment (fertilization and protection), it can only display recommendations coming from external models, without any determination of the duration or the level of protection of the crop.

This invention also aims to remedy these drawbacks.

To this end, according to a first aspect, this invention relates to a method helping with crop treatment recommendations, characterized in that it combines a field record, models of plants, diseases or insects and active substances coupled together, and comprises, at least once, the following steps:
a step in which the risk of contracting diseases to which the crop is exposed is determined, according to the results of a disease or insect model coupled with the plant model,
a step in which the level of protection of the crop is determined based on the last treatment applied, according to the results of a model of active substances coupled with the field record and the plant model,
a step in which the next recommended treatment is determined, according to the modeled change in the crop and in the disease or insect since the last treatment carried out and
a step in which the next recommended treatment is displayed.

It should be noted that, because the evolution of the implemented crop is modeled, it is not mandatory to perform field measurements to obtain the recommendations.

With these arrangements, the plant's modeled growth since the last treatment was applied is taken into account to determine the recommendation, which ensures a more accurate recommendation. The recommendation is thus not defined by calendar dates but by the crop's modeled development stage during which the recommended active substance can be used. The effective date for using an active substance can thus vary from year to year, depending on whether the crop is more or less early.

According to particular characteristics, the step in which the next recommended treatment is determined comprises a step in which a user selects a type of active substance to be applied.

The present invention thus provides a decision support tool that allows a farmer or agricultural consultant to realize simulations using agro-climatic models on every plot of the farm.

According to particular characteristics, the step in which the next recommended treatment is determined determines said next recommended treatment based on the active substances already used on the crop.

According to particular characteristics, the step in which the next recommended treatment is determined determines said next recommended treatment according to parasite pressure. Treatment can thus be avoided if the risk of infection and/or attack is zero.

According to particular characteristics, the method that is the subject of the present invention, as described in brief above, comprises a step in which the shift in stage dates is determined by reading values from field observations, by reading values from sensors or by querying a remote computer model.

According to particular characteristics, the step in which the next recommended treatment is determined is performed remotely, on a site reachable via the Internet.

Thus, the service implementing the present invention is preferably fully accessible via the Web, both by farmers and their advisors.

According to a second aspect, this invention relates to a device helping with crop treatment recommendations, characterized in that it combines a field record, models of plants, diseases or insects and active substances coupled together, and comprises:
means whereby the risk of contracting diseases to which the crop is exposed is determined, according to the results of a disease or insect model coupled with the plant model,
means whereby the level of protection of the crop is determined based on the last treatment applied, according to the results of a model of active substances coupled with the field record and the plant model,
means whereby the next recommended treatment is determined, according to the modeled change in the crop and the disease or insect since the last realized treatment and
means whereby the next recommended treatment is displayed.

As the particular characteristics, advantages and aims of this device are similar to those of the method that is the subject of the first aspect of this invention, as described in brief above, they are not repeated here.

In the case of crops, in particular fruit or wine crops, which require frequent and repeated treatments constituting a treatment program, it is necessary to take the soil persistence of each active substance into account to determine the number of treatments to be applied. In these situations, the date of first treatment applied is determined based on a stage of the crop, but the dates of subsequent applications of the active substances are based on the constraints linked to the crop's developmental stages and to the time interval since the previous treatment.

For a given crop, several active substances with different targets can be recommended during the same period. In this case, there is a risk of either applying active substances together that must not be mixed, or of increasing the number of treatment dates.

All of these constraints lead to great complexity in determining the application dates of a single active substance or of different active substances.

Recording the recommendations is thus a complex matter. In addition, it must be possible to record recommendation data very quickly during short visits to the farmer, without disrupting the commercial negotiation process of the technical sales consultants.

In the currently known traceability computer systems, the treatments applied to a crop are entered in a classical input window, in which the name of the active substance, the dose to be applied, and either a treatment date, or a stage of the crop are indicated. When repeated treatment is to be applied, the dates of successive treatments must be calculated mentally. Because these procedures are complex and lengthy, many consultants merely keep to a paper record and, possibly, input the data after the visit to the farmer. Thus, the risk of errors and forgetfulness increase, at the expense of consumer food safety, which is the goal of this traceability.

The present invention aims to remedy all or part of these drawbacks. To this end, according to a third aspect, the present invention relates to a method for supervising the treatment of a crop, characterized in that it comprises:

a step in which the stages of a crop's cycle are displayed and

at least once, the following steps:
a step in which a type of active substance is selected,
a step in which a date of first application of the active substance is selected, with regard to one said stage, and
an automatic step in which the soil persistence of said active substance on said crop is displayed, opposite at least one said stage, using the same time scale as that used to display said stage, and

a step in which each type of active substance and each selected date are stored.

Thanks to these arrangements, the consultant and/or farmer can easily determine and store the recommendations and the needs to repeat each crop's treatment with each recommended active substance, since the soil persistence is automatically displayed opposite the crop cycle stages.

It should be noted here that water is not considered an active substance.

According to particular characteristics, during the step in which the stages of a crop's cycles are displayed, the stages are displayed opposite the usual calendar dates of these stages.

Thanks to these arrangements, the average recommended treatment months and days can be visualized over several campaigns.

According to particular characteristics, the method that is the subject of the present invention, as described in brief above, comprises a step in which the shift in stage dates is determined by reading values from field observations, by reading values from sensors or by querying a remote computer model.

Thanks to these arrangements, determining the lead or lag in the crop's cycle can be performed automatically and allow a new recommendation, a new memorization of recommendation and/or a reprint of the recommendations carried out.

Thus, the plant's growth since the last treatment was applied is taken into account to determine the recommendation, which ensures a more accurate recommendation. The recommendation is not defined by calendar dates but by the crop's development stage during which the recommended active substance can be used. The effective date for using an active substance can thus vary from year to year, depending on whether the crop is more or less early.

According to particular characteristics, if, during the step in which at least one calendar date of commencement of application of said active substance is selected, two calendar dates separated by an interval close to the soil persistence of the first product applied are selected, the corresponding soil persistences are automatically placed end-to-end during the automatic step in which the action persistence duration is displayed.

Thanks to these arrangements, recommending two successive treatments, either superimposed or separated by a period during which the crop would have no more active treatment, is avoided.

According to particular characteristics, the method that is the subject of the present invention, as described in brief above, also comprises a step, within the step in which the next recommended treatment is determined, in which a user selects a type of active substance to be applied.

The present invention thus provides a supervision and decision support tool that allows a farmer or agricultural consultant to realize simulations using agro-climatic models on every plot of the farm.

According to particular characteristics, the step in which the next recommended treatment is determined determines said next recommended treatment based on the active substances already used on the crop.

This prevents incompatible treatments from being applied.

According to particular characteristics, the step in which the next recommended treatment is determined determines said next recommended treatment according to parasite pressure.

Treatment can thus be avoided if the risk of infection and/or attack is zero.

According to particular characteristics, the method that is the subject of the present invention, as described in brief above, also comprises a step in which the name of an active substance is selected and, in the automatic step in which the soil persistence is displayed, said active substance name is displayed, either superimposed over or juxtaposed with the soil persistence.

Thanks to these arrangements, the active substance to be applied, its application date and its duration of action are precisely visualized. This avoids possible misinterpretation of graphics.

According to particular characteristics, during the step in which at least one calendar date of commencement of application of said active substance is selected, a pointing device controlling the display of a cursor, a moving line connecting said point position to a line of stages of a crop's cycle and a line of calendar dates, along an orthogonal projection.

Thanks to these arrangements, positioning of the start of the treatment is both easy, for example by using a mouse, and accurate, as the moving line indicates the exact date selected.

According to particular characteristics, if, during successive selection stages, at least two active products are selected, whose soil persistence overlap, a compatibility check between said active substances is performed.

Thus a check is carried out to ensure that this additional treatment does not infringe the rules of proper use of plant protection products.

According to particular characteristics, if calendar dates close to each other are selected during successive steps of selecting at least two active substances, these application dates are grouped in the automatic display step.

Thanks to these arrangements, the active substances are combined into a single treatment to save time for the farmer.

According to particular characteristics, in the automatic step in which the soil persistence is displayed, if said selected stage of the crop cycle is not completed by the end of the soil persistence, an additional treatment of the same active substance at the end of the soil persistence is automatically displayed.

Thanks to these arrangements, extended coverage of the crop cycle in question is recommended automatically.

According to particular characteristics, the step in which the next recommended treatment is determined is performed remotely, on a site reachable via the Internet.

Thus, the service implementing the present invention is preferably fully accessible via the Web, both by farmers and their advisors.

According to a fourth aspect, the present invention relates to a device for supervising the treatment of a crop, characterized in that it comprises:
a means whereby the stages of a crop's cycle are displayed and
a processing means designed to perform the following at least once:
   select one type of active substance,
   select a date of first application of the active substance opposite one said stage,
   display the soil persistence of said active substance on said crop automatically, opposite at least one said stage, using the same time scale as that used to display said stages, and
a means whereby each type of active substance and each selected date are stored.

As the particular characteristics, advantages and aims of this device are similar to those of the method that is the subject of the third aspect of this invention, as described in brief above, they are not repeated here.

According to a fifth aspect, the present invention envisages a computer program, characterized in that it comprises instructions that can be executed by a computer in order to implement the method that is the subject of the first or third aspect of this invention, as described in brief above.

According to a sixth aspect, the present invention envisages a data carrier that can be read by a computer and comprising instructions that can be executed by a computer in order to implement the method that is the subject of the first or third aspect of this invention, as described in brief above.

As the particular characteristics, advantages and aims of this computer program and this data carrier are similar to those of the method that is the subject of the first or third aspect of this invention, as described in brief above, they are not repeated here.

The various aspects of the present invention are designed to be implemented together to make a unified crop treatment monitoring tool. The particular characteristics of each of the aspects of the present invention therefore constitute particular characteristics of the embodiments of the other aspects of the present invention.

Other advantages, aims and characteristics of the present invention will become apparent from the description that will follow, made, as an example that is in no way limiting, with reference to the drawings included in an appendix, in which:

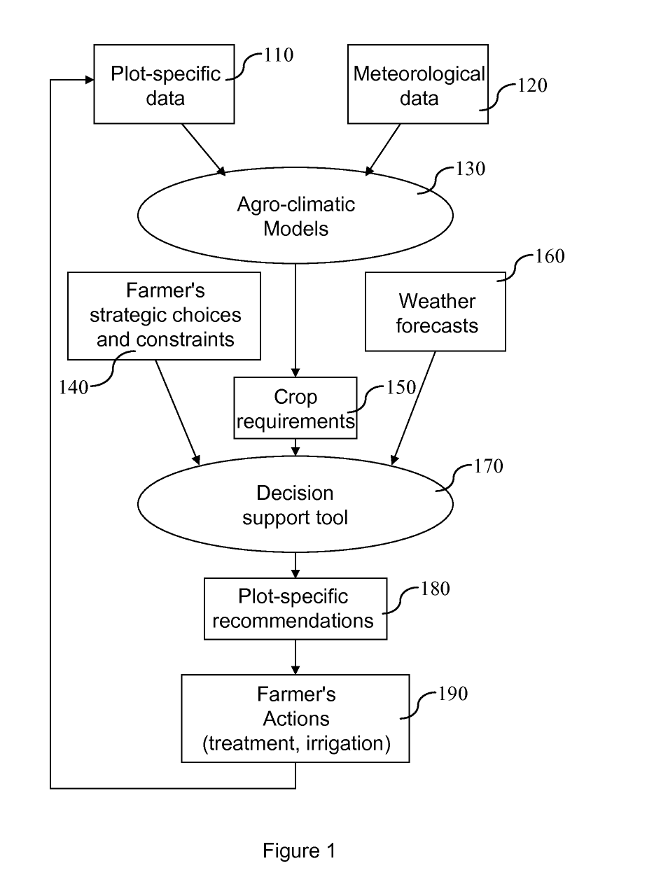

FIG. 1 shows, schematically, functional modules of a service implementing the method that is the subject of the present invention,

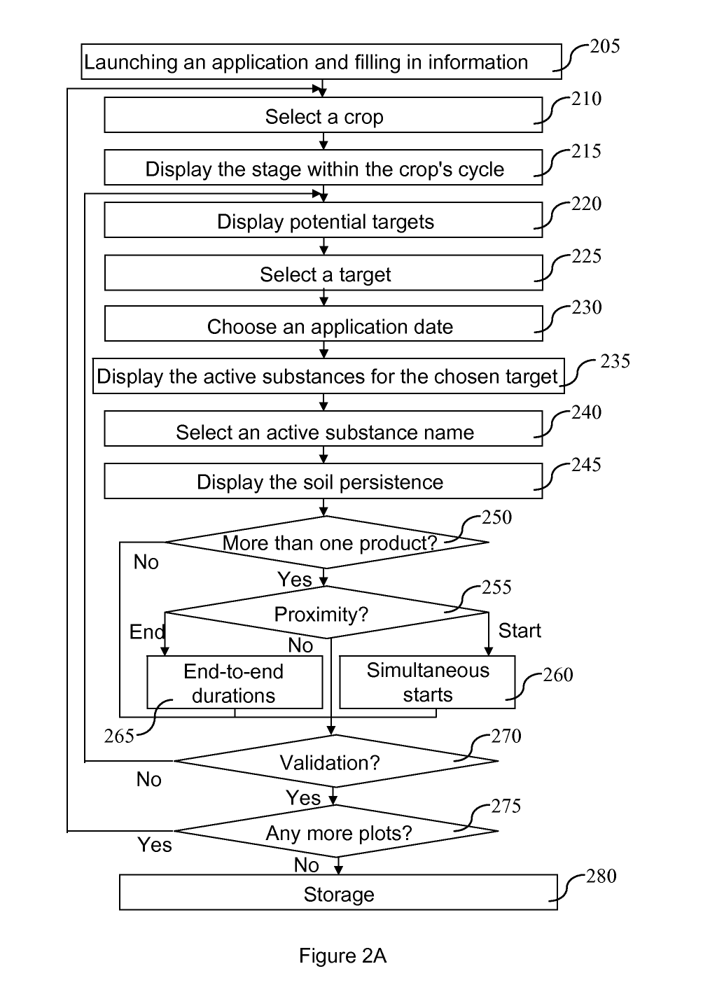

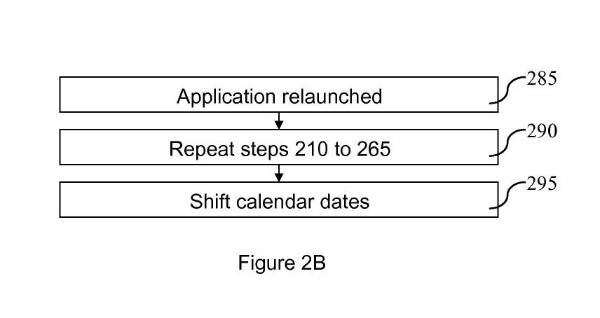

FIGS. 2A and 2B represent, in the form of logical diagrams, steps utilized in a particular embodiment of the method that is the subject of the present invention, and

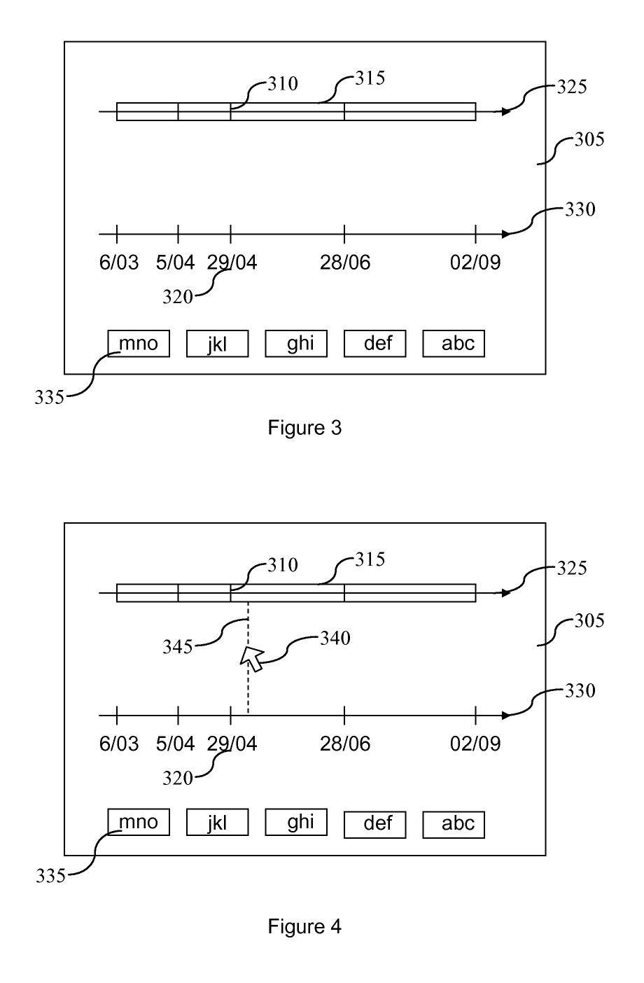

FIGS. 3 to 8 show, schematically, pages displayed during the implementation of the steps of the method illustrated in FIG. 2A,

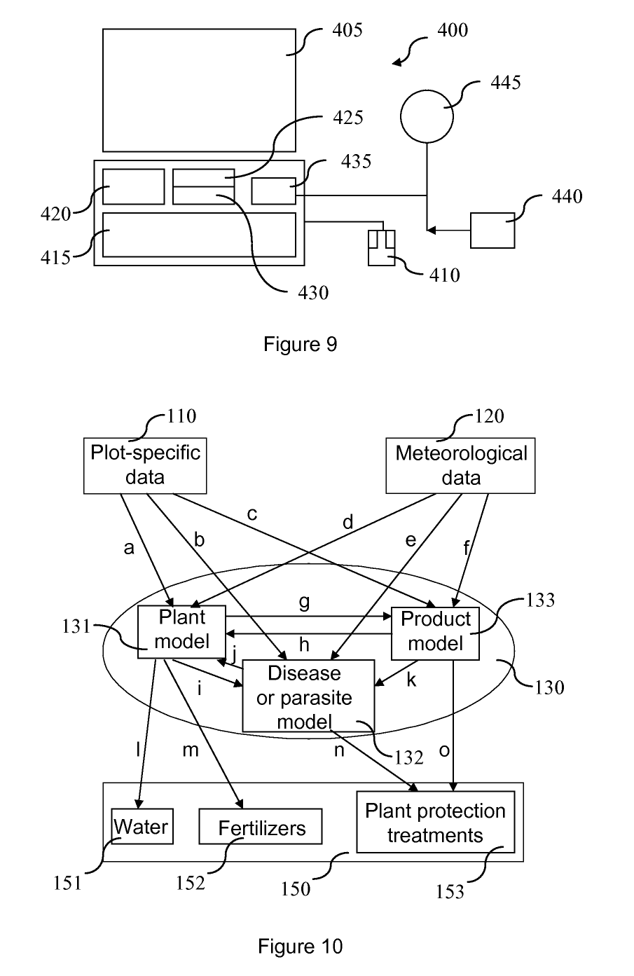

FIG. 9 represents, schematically, a particular embodiment of the device that is the subject of the present invention and

FIG. 10 describes, schematically, steps in which the requirements of a crop are calculated.

It can be seen in FIG. 1, that the supervision or decision support tool 170 which implements the method that is the subject of the present invention operates in an iterative process. It implements the farmer's strategic choices and constraints 140, weather forecasts 160 and crop needs 150 as determined by agro-climatic models 130 based on plot data 110 and meteorological data 120.

As output, the supervision tool 170 provides plot-specific recommendations 180 for the intervention 190 of the farmer on the plot concerned by the recommendation. Once this operation has been realized, the plot-specific data 110 are updated accordingly.

This tool 170 combines, within the same service, preferably accessible on the Web:

plot data entry functions for the farm, compliant with the same standards as plot management software (it is therefore possible to import data from the farm's software, if it has already been entered therein),

models of plants and diseases for the main crops covered by sustainable production,

models of active substances, which allow the period during which the crop is effectively protected by the treatments realized by the farmer to be known, based on the characteristics of the active substance applied, the risk of disease and crop growth since the treatment last applied and

where this tool 170 is used by a technician it includes, in addition, a module for recording recommendations, described elsewhere.

It is recalled here that water is not considered an active substance.

This tool 170 thus allows the full potential of agro-climatic models to be used. It allows their use to be increased and farmers themselves to be involved in the sustainability process, thanks to its accessibility over the Internet in particular. Indeed, all the operations are preferably performed by a single Web service, accessible to the farmers and their consultants if any.

It can be seen that the agro-climatic models 130 preferably take parasite pressure into account and include at the same time plant/crop models, disease models, and plant protection product models. Preferably, the tool 170 implements an expert system. With the inclusion of parasite pressure, treatment can be avoided if the risk of infection/attack is zero.

Note that the plot data 110, the farmers' strategic choices and constraints 140 and the interventions carried out 190 are information known to the farmers, which they enter themselves or get their consultant to enter. The plot data 110 and interventions carried out 190 can possibly be entered into the farmers' plot management software, and imported by the tool 170 that implements the present invention.

Indeed, farmers are more and more likely to use plot management and traceability software, in which they record descriptions of all their plots and of all the procedures that they perform on them. These plot management software programs already record most of the plot information necessary for an agro-climatic model to function. Plot management and traceability software are therefore a source of information for the tool 170.

The meteorological data 120 and weather forecasts 160 are external data ordered and managed by this tool 170.

FIG. 10 details some elements of steps of calculating the requirements of the crop. In it, it can be seen that the agro-climatic models 130 comprise, in particular, at least one plant model 131, at least one disease or parasite model 132 and at least one active substance model 133. The crop needs 150 comprise the water requirements 151, fertilizer requirements 152 and plant protection treatment requirements 153.

Plot-specific data, usually entered into plot management software (soil type, established crop, interventions carried out), are used as input variables to the three model categories:

the soil and crop data serve as input to the plant model (arrow 110-131a),

the interventions carried out by the farmer serve as input data to the active substance model (arrow 110-133c) and

in some cases, certain soil or crop characteristics are used as input data to the disease or parasite model (arrow 110-132b).

The meteorological data are used in all three model categories (in the case of the active substance model, they help determine whether the active substance last applied was or not washed away by rain) (arrows 120-131d, 120-132e and 120-133f).

The coupling between three model types is a key innovation of the system which is the subject of the third and fourth aspects of the present invention.

The plant model 131 calculates the crop's development state (phenological stage, biomass production). From this, the plant model 131 derives the crop's requirements for water 151 and fertilizing elements 152 (arrows 131-151l and 131-152m). The plant model 131 also indicates the sensitivity of crop (arrow 131-132i) to the disease or parasite model 132, and indicates to the active substance model 133 the modeled evolution of the vegetative surface since the last treatment was carried out (arrow 131-133g)

The disease or parasite model 132 calculates the epidemic's development state (or the state of the insect populations) and deduces from this whether the crop requires treatment (arrow 132-153n). In some cases, it also interacts with the plant model 131 to calculate the leaf area destroyed, or the yield loss caused (arrow 132-131j).

The active substance model 133 calculates the crop's level of protection against the disease or parasite present (arrow 133-131h), to correct the level of the epidemic or parasite populations taking the efficiency or the treatments applied into account (arrow 133-132k). The active substance model 133 also specifies, if a treatment is required, what category of active substance is most appropriate (arrow 133-153o).

In FIG. 9, a device 400, that is the subject of the present invention, comprising a display 405, a pointing device 410, a keyboard 415, a microprocessor 420, random-access memory 425, nonvolatile memory 430 and an I/O port 435 can be seen.

The device 400, for example, comprises a general purpose computer, preferably portable, equipped with appropriate programs to implement the present invention and/or software to access a Web service implementing the method that is the subject of the present invention. The service performed by the present invention can thus be used both locally and, preferably, in Web client/server mode, making it fully accessible via the Internet, both by the farmers and their consultants if any.

The screen 405 is of a known type. It allows pages generated by the microprocessor 420 to be displayed, possibly with the assistance of a graphics controller (not shown). The pointing device 410 is of a known type, e.g. a mouse or a device simulating a mouse. The keyboard 415 is of a known type. It can be seen that it is optional for the implementation of the present invention. The microprocessor 420 is of a known type. The random access memory 425 is associated with the microprocessor 420 and allows it to run faster by storing program instructions and data being used by the microprocessor 420. The nonvolatile memory 430, for example, consists of a hard drive or a memory key, e.g. a so-called “USB” (acronym for Universal Serial Bus) key, named for its type of connection port.

The I/O port 435 allows the program implementing the method that is the subject of the present invention to be loaded; it also allows data to update the program or data representing the stage of crop cycles to be received. For example, these data come from field observations or from sensors 440 installed on the ground, such as temperature, humidity, rainfall, insolation and fruit maturity sensors. According to a second example, the data come from servers (not shown) providing, via a network 445, e.g. the Internet, an indication of these stages.

The I/O port 435 also allows the results of the implementation of the present invention to be transferred via the network 445 to a remote server (not shown), where the traceability data, i.e. the recommendation data and their printing dates, are kept. Possibly, this server also allows orders and invoices for active substances sold to the farmer to be prepared.

The nonvolatile memory 430 stores the instructions of a program implementing the method that is the subject of the present invention, for example by carrying out the steps illustrated in FIGS. 2A and 2B.

By implementing this program, the device 400 allows the traceability of recommendations to be assured, by comprising:

a means of displaying the stages of a crop's cycle, here the display associated with the CPU, and

a processing means, here the CPU, designed to:
assist in selecting a type of active substance,
assist in selecting a date of first application of the active substance with regard to one said stage,
calculate a soil persistence of said active substance on said crop and
control the display of the duration of soil persistence of said active substance on said crop, opposite at least one said stage; and

a means of storing, here the non-volatile memory associated with the CPU, each type of active substance and each recommended stage.

In FIG. 2A, first, a step 205 can be seen, in which a computer application is launched, which is designed to run an embodiment of the method that is the subject of the present invention. During this launch step, the farmer's name and the names of the plots they farm are entered.

In a step 210, a user, e.g. a consultant or an active substance salesperson, selects a crop from various possible crops, using, for example, a drop-down menu or a list of crops.

Then, during a step 215, the device performs the display of the stages of a cycle of the selected crop. FIG. 3 shows a page 305 that can be displayed during step 215. To this end, for each crop that can be selected, the computer application comprises the various stages of its cycle, e.g. “emergence”, “3 leaves,” “start flowering,” “maturity”. In variants, these data, as well as that listed below, are read from storage in a remote server. Preferably, during this step 215, the usual start calendar dates 320 are displayed simultaneously and opposite the starts 310 of the various stages of the selected crop 315 (i.e. the average over several years and several farms, of the dates of occurrence of these stages). The stages 310 and calendar dates 320 are preferably represented along two parallel lines 325 and 330, with the same time scale.

In a step 220, potential targets 335 associated with the selected crop are displayed as a list, icons or a drop-down menu.

During a step 225, the user selects a target associated with the selected crop. Preferably, for this purpose, the user points to a target with the mouse and presses the left mouse button down.

During a step 230, the user selects a treatment date by dragging the cursor 340 to the space between the two parallel lines mentioned above (stages of the crop cycle and calendar dates). The user then releases the left mouse button. Preferably, during a step 230, a moving line 345 is generated linking the cursor position to lines 325 and 330 along an orthogonal projection, as illustrated in FIG. 4. In FIG. 4, since lines 325 and 330 are horizontal, the mobile line 345 associated with the cursor 340 is vertical. Thus, positioning the start of the treatment is both easy, thanks for example to the use of a mouse, and accurate, as the moving line indicates the exact date selected or the start of the stage in question.

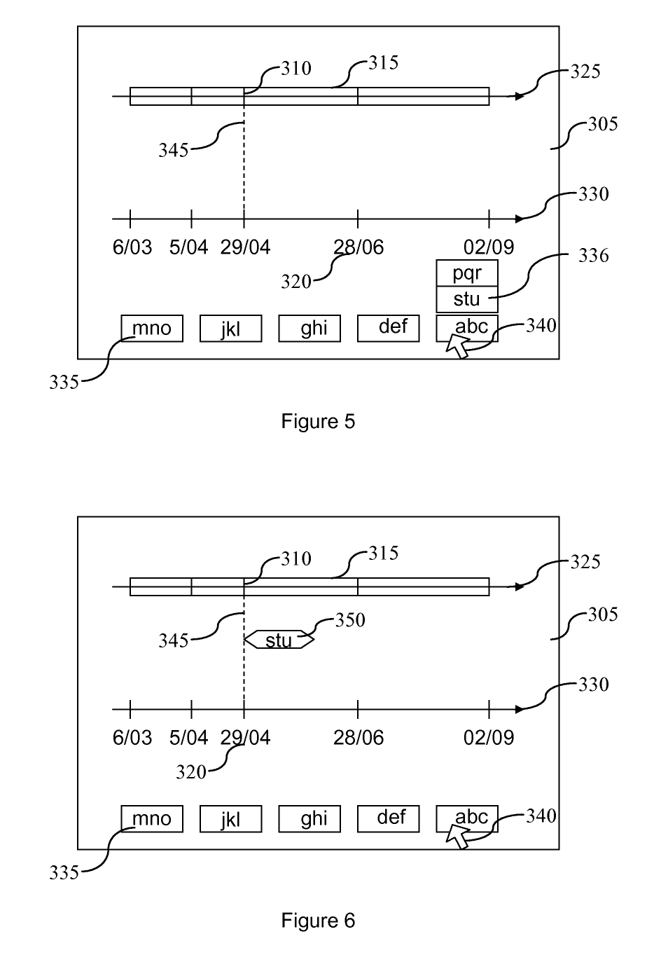

In a step 235, active substances and treatments 336 that may be associated to the selected target are displayed as a list or drop-down menu (in FIG. 5, these active substances and treatments appear in a popup window) above the selected target “abc”.

During a step 240, the user selects an active substance or treatment to be applied to the selected crop.

As soon as the user releases the left mouse button, the soil persistence 350 of said active substance on said crop is automatically calculated and displayed, using the same time scale as that used in the display of said stages, in a step 245 (see FIG. 6).

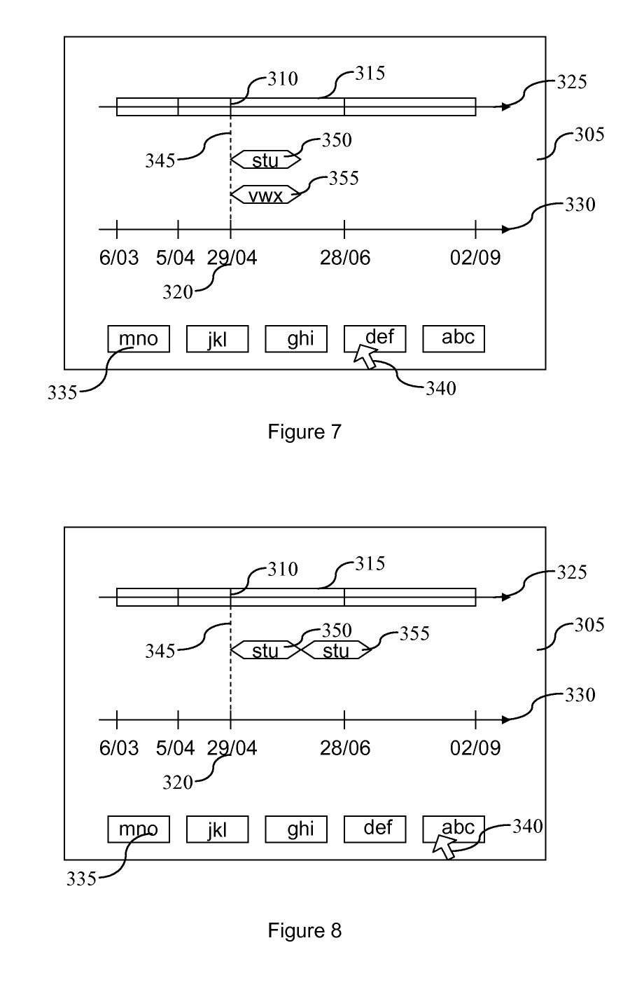

In a step 250 it is determined whether more than one treatment or one active substance has been selected. If not, proceed to step 270. If yes, during a step 255 it is determined whether the start of the new soil persistence of the active substance or treatment is near the beginning or end of a previously-set duration. Here, the term “near” means, at a distance, in terms of dates, less than a predefined value, e.g. two days. If not, proceed to step 270. If the start of the new duration 355 is near the beginning of a soil persistence already displayed, during a step 260, these two start dates are automatically brought into line, as shown in FIG. 7. Thanks to these arrangements, treatments can be combined to save time for the farmer. However, if the user subsequently re-selects the initial date 355 by a mouse “click”, this automatic shift is not repeated. Then proceed to step 270.

Conversely, if the start of the new duration 355 is near the end of a soil persistence already displayed corresponding to the same treatment or the same active substance, during a step 265, these two dates are automatically brought into line, as shown in FIG. 8. Thanks to these arrangements, recommending two successive treatments, either superimposed or separated by a period during which the crop would have no more active treatment is avoided. However, if the user subsequently re-selects the initial date 355 by a mouse “click”, this automatic shift is not repeated. Then proceed to step 270.

In step 270, it is determined whether the user has validated the end of the selection of active substances or treatments for the plot in question. If not, return to step 220. If yes, during a step 275, it is determined if there are more plots to consider. If yes, return to step 210 for the next plot of the farmer concerned.

If not, in a step 280, each selected crop, the farmer's name, the plot number, each type of recommended active substance and each stage is stored locally and/or remotely and a list of dates and soil persistences of recommended active substances or treatments is printed.

To realize the recommendation, a field record, models of plants, diseases or insects and active substances coupled together are combined, and the following steps are performed at least once:
determining the risk of contracting diseases to which the crop is exposed, according to the results of a disease or insect model coupled with the plant model,
determining the level of protection of the crop, based on the last treatment applied, according to the results of a model of active substances coupled with the field record and the plant model and
determining the next recommended treatment, according to the modeled change in the crop and the disease and/or insect since the last realized treatment.

It should be noted that, because the evolution of the implemented crop is modeled, it is not mandatory to perform field measurements to obtain the recommendations.

It should be noted that these stored recommendations indicate precisely:

the list of plots affected by the recommendation,

the exact name of the recommended active substances,

their use dosage,

the period of the year during which the active substances can be used and

the target of the recommended active substance (e.g. the disease or insect it can eliminate).

As is easily understood, by implementing the present invention, the consultant and/or farmer can easily determine and store the recommendations and the needs to repeat each crop's treatment with each active substance recommended, since the soil persistence is automatically displayed opposite the crop cycle stages.

If the application is run again for the same farmer subsequently, step 285 (FIG. 2B), in a step 290, steps 210 to 280 described above can be repeated. In a step 295, stages and calendar dates can also be shifted, since the soil persistences are fixed in relation to said stages during this shifting step 295. Thus, when an advance or lag in the crop cycle is observed, the recommended calendar dates of treatment can be adjusted accordingly. Note that step 295 can be performed automatically when sensors on the ground are implemented or when a remote server is queried, which is capable of supplying the stage shifts observed in relation to the average first used during the step 215. The device then performs an automatic determination of date shifts of stages based on observations in the field, by reading values from sensors or by querying a remote computer system. The determination of whether the crop cycle is early or late can be performed automatically and allow a new recommendation to be made, a new storage of recommendations and/or a reprint of the recommendations to be made.

In a variant, not shown in FIG. 2A, in the automatic step in which the soil persistence is displayed, if said selected stage of the crop cycle is not completed by the end of the soil persistence, an additional treatment of the same active substance at the end of the soil persistence is automatically displayed. Thus, extended coverage of the crop cycle in question is recommended automatically. A check allows verification of whether the addition of this treatment complies with the rules of appropriate use of active substances. The user can, for example via a double click of the mouse, eliminate this automatically generated treatment or confirm it.

1-17. (canceled)

18. Method for supervising the treatment of a crop, that combines a field record, models of plants, diseases or insects and active substances coupled together, and comprises, at least once, the following steps:
a step in which the risk of contracting diseases to which the crop is exposed is determined, according to the results of a disease or insect model coupled with the plant model,
a step in which the level of protection of the crop is determined based on the last treatment applied, according to the results of a model of active substances coupled with the field record and the plant model,
a step in which the next recommended treatment is determined, according to the modeled change in the crop and the disease and/or insect since the last treatment carried out and
a step in which the next recommended treatment is displayed.

19. The method according to claim 18, wherein the step in which the next recommended treatment is determined comprises a step in which a user selects a type of active substance to be applied.

20. The method according to claim 18, wherein the step in which the next recommended treatment is determined determines said next recommended treatment based on the active substances already used on the crop.

21. The method according to claim 18, wherein the step in which the next recommended treatment is determined determines said next recommended treatment according to parasite pressure.

22. The method according to claim 18, further comprising a step in which the shift in stage dates is determined by reading values from field observations, by reading values from sensors or by querying a remote computer model.

23. The method according to claim 18, wherein the step in which the next recommended treatment is determined is performed remotely, on a site reachable via the Internet.

24. The method according to claim 18, further comprising:
a step in which the stages of a crop's cycle are displayed and
at least once, the following steps:
a step in which a type of active substance is selected,
a step in which a date of first application of the active substance is selected, with regard to one said stage, and
an automatic step in which the soil persistence of said active substance on said crop is displayed, opposite at least one said stage, using the same time scale as that used to display said stage, and
a step in which each type of active substance and each selected date are stored.

25. The method according to claim 24, wherein during the step in which the stages of a crop's cycles are displayed, the stages are displayed opposite the usual calendar dates of these stages.

26. The method according to claim 24, that comprises a step in which the shift in stage dates is determined by reading values from field observations, by reading values from sensors or by querying a remote computer model.

27. The method according to claim 24, wherein if, during the step in which at least one calendar date of commencement of application of said active substance is selected, two calendar dates separated by an interval close to the soil persistence of the first product applied are selected, the corresponding soil persistences are automatically placed end-to-end during the automatic step in which the action persistence duration is displayed.

28. The method according to claim 24, that further comprises a step in which the name of an active substance is selected and, in the automatic step in which the soil persistence is displayed, said active substance name is displayed, either superimposed over or juxtaposed with the soil persistence.

29. The method according to claim 24, wherein during the step in which at least one calendar date of commencement of application of said active substance is selected, a pointing device controlling the display of a cursor, a moving line connecting said point position to a line of stages of a crop's cycle to a line of calendar dates, along an orthogonal projection.

30. The method according to claim 24, wherein if, during successive selection stages, at least two active substances are selected whose periods of action overlap, a compatibility check between said active substances is performed.

31. The method according to claim 24, wherein if, during successive steps of selecting at least two active substances, calendar dates close to each other are selected, these application dates are grouped in the automatic display step.

32. Method according to claim 24, wherein in the automatic step in which the soil persistence is displayed, if said selected stage of the crop cycle is not completed by the end of the soil persistence, an additional treatment of the same active substance at the end of the soil persistence is automatically displayed.

33. Method according to claim 18, wherein during the step in which the next recommended treatment is determined, a user selects a type of active substance to be applied; said next recommended treatment is based on the active substances already used on the crop and/or on the parasite pressure.

34. The method according to claim 19, wherein the step in which the next recommended treatment is determined determines said next recommended treatment based on the active substances already used on the crop.

35. Device for supervising the treatment of a crop, that combines a field record, models of plants, diseases or insects and active substances coupled together, and comprises:
means whereby the risk of contracting diseases to which the crop is exposed is determined, according to the results of a disease or insect model coupled with the plant model,
means whereby the level of protection of the crop is determined based on the last treatment applied, according to the results of a model of active substances coupled with the field record and the plant model,
means whereby the next recommended treatment is determined, according to the modeled change in the crop and the disease and/or insect since the last realized treatment and
means whereby the next recommended treatment is displayed.
